(19) United States
(12) Patent Application Publication
(10) Pub. No.: US 2001/0035648 A1
(43) Pub. Date: Nov. 1, 2001

(54) Plumbing fitting with hub

(76) Inventor: Gabe Coscarella, Edmonton (CA)

Correspondence Address: Davis and Bujold, Fourth Floor, 500 N. Commercial Street, Manchester, NH, 03101, US

(21) Appl. No.: 09/745,577

(22) Filed: Dec. 21, 2000

(30) Foreign Application Priority Data
Apr. 27, 2000 (CA) 2, 307, 168

(51) Int. Cl. F16L 55/00

(52) U.S. Cl. 285/148.11

(57) ABSTRACT

A pipe fitting with hub includes a hollow primary body having an incomplete hub integrally formed as part of the primary body. The incomplete hub has a first engagement. A hub completion member is provided which is separate from the primary body. The hub completion member has a second engagement adapted to engage the first engagement. By coupling the hub completion member to the incomplete hub a composite hub is formed on the primary body. This form of construction enables a PVC primary body to be used with either PVC or ABS hub completion members, to adapt the pipe fitting for use with either PVC or ABS pipe.

### FIELD OF THE INVENTION

The present invention relates to a plumbing fitting that has one or more hubs for connecting to lengths of plastic pipe.

### BACKGROUND OF THE INVENTION

The term “pipe fitting” is used to describe a wide range of pipe connectors including elbows, tees, line clean outs, adapters, in-line backwater valves, traps, couplings for like diameter pipe and couplings for differing diameter pipe. The term “hub” is used to describe the female portion of the pipe fitting into which a pipe is inserted and secured with adhesive.

The two types of plastic pipe most frequently used in plumbing applications are polyvinyl chloride (PVC) and acrylonitrile butadiene styrene (ABS). Unfortunately, problems are encountered in adhering PVC to ABS. For that reason, when working with PVC pipe, all fittings used must be made from PVC; conversely, when working with ABS pipe, all fittings used must be made from ABS. The inventory of fittings which must be maintained due to this problem is costly.

### SUMMARY OF THE INVENTION

What is required is a plumbing fitting with hub that can be used to accommodate PVC pipe, ABS pipe, and pipe made from other materials.

According to the present invention there is provided a pipe fitting with hub which includes a hollow primary body having at least one incomplete hub integrally formed as part of the primary body. The incomplete hub has a first engagement. At least one hub completion member is provided which is separate from the primary body. The hub completion member has a second engagement adapted to engage the first engagement. By coupling the hub completion member to the incomplete hub a composite hub is formed on the primary body.

The primary body of the pipe fitting, as described above, has an incomplete hub which renders the pipe fitting useless until the hub completion member is added to form a composite hub on the body. The hub completion member is selected which is either PVC or ABS, depending upon the pipe that is being used. The primary body can be made out of any desired material. In view of cost considerations, it is anticipated that it will be made from plastic; likely either PVC or ABS. The hub completion member selected will be of PVC, if adhesive is being used to secure PVC pipe to the composite hub; or ABS, if adhesive is being used to secure ABS pipe to the composite hub. The composite hub is secured together by engaging the first engagement with the second engagement. There are various types of engagement that can be used, two alternatives will hereinafter be illustrated and described; those being a threaded engagement and a snap locking engagement.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a backwater valve style of pipe fitting having composite hubs constructed in accordance with the teachings of the present invention.

FIG. 2 is an exploded side elevation view, in section, of the pipe fitting illustrated in FIG. 1.

### DETAILED DESCRIPTION OF THE PREFERRED EMBODIMENT

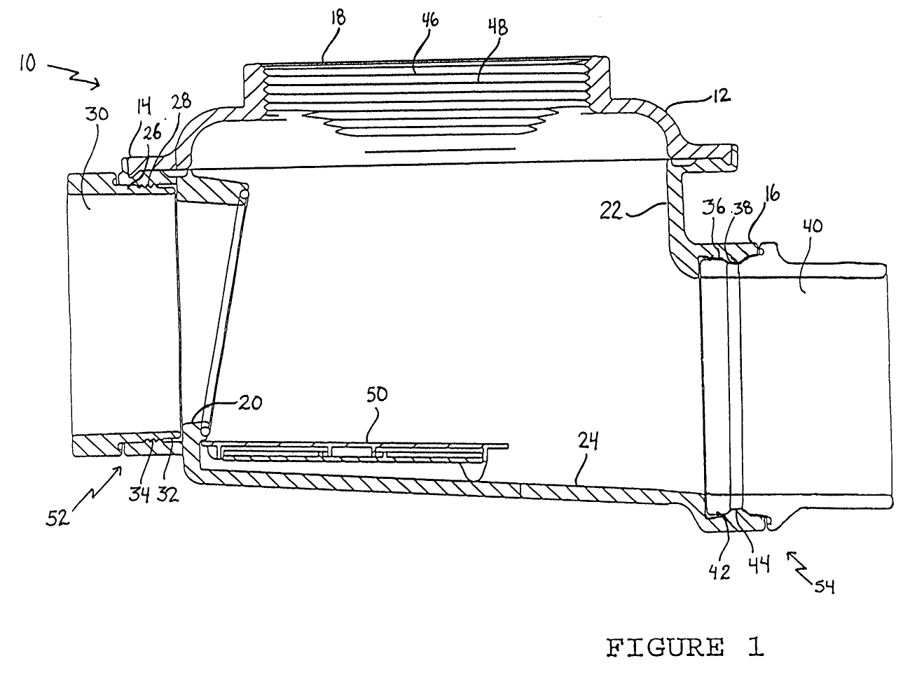

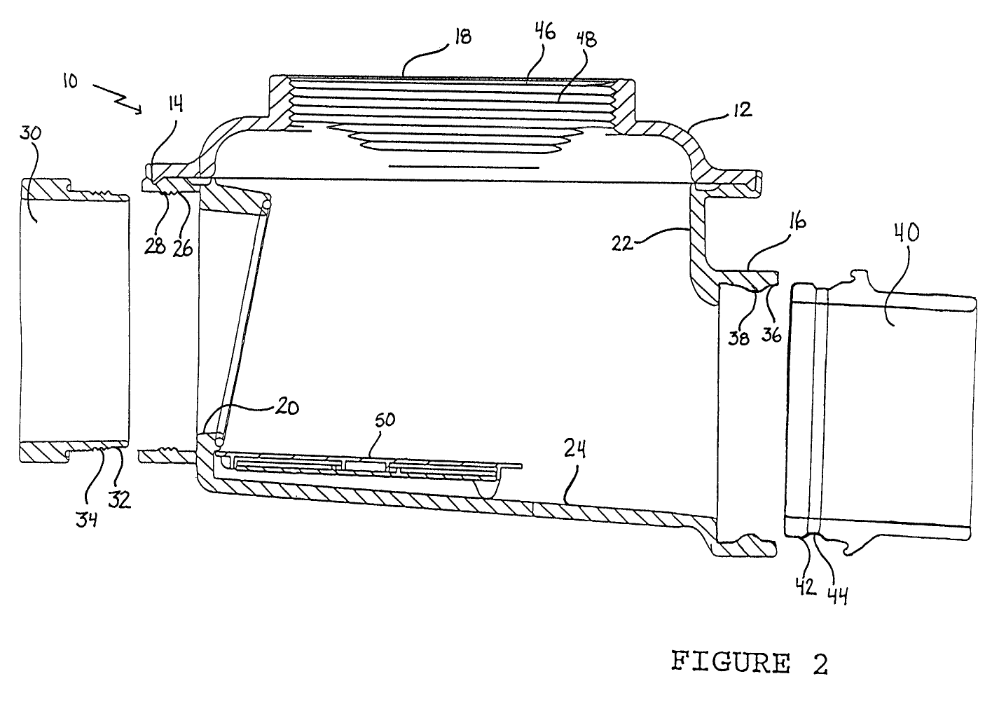

The preferred embodiment, a pipe fitting with hub generally identified by reference numeral 10, will now be described with reference to FIGS. 1 and 2.

Structure and Relationship of Parts:

Referring to FIG. 2, there is provided a pipe fitting 10 which includes a hollow primary body 12, a first hub completion member 30 and a second hub completion member 40. The particular type of pipe fitting selected is a backwater valve, it will be appreciated that another form of fitting could have been used for the purpose of illustration. In the illustrated embodiment, a first incomplete hub 14, a second incomplete hub 16, and a threaded clean out opening 18 are all integrally formed as part of primary body 12. Primary body 12 has a first end 20, a second end 22, and a sidewall 24. First incomplete hub 14 is located at first end 20 of primary body 12 and has a first engagement 26 in the form of internal engagement threads 28. First hub completion member 30 is separate from primary body 12. Hub completion member 30 has a second engagement 32 in the form of external engagement threads 34 adapted to engage internal engagement threads 28. Second incomplete hub 16 is located at second end 22 of primary body 12 and has a first engagement 36 in the form of an internal annular ridge 38. Second hub completion member 40 is separate from primary body 12. Hub completion member 40 has a second engagement 42 in the form of an external annular groove 44 adapted to engage internal annular ridge 38. Threaded clean out opening 18 has an engagement 46 with inner threads 48. Unlike first engagement 26, threaded clean out opening 18 is complete and not just partial. Inner threads 46 are adapted to engage with a threaded closure member (not shown). A closure gate 50 is pivotally mounted to sidewall 24 inside of primary body 12. Closure gate 50 moves to a closed position upon a reversal of flow.

Operation:

The use and operation of pipe fitting 10 will now be described with reference to FIGS. 1 and 2. First hub completion member 30 and second hub completion member 40 are selected out of either PVC or ABS depending on the type of pipe that is being used. Referring to FIG. 1, first hub completion member 30 is secured to first incomplete hub 14 so that a first composite hub 52 is formed on first end 20 of primary body 12. Composite hub 52 is a female hub secured together by threading internal engagement threads 28 of first engagement 26 with external engagement threads 34 of second engagement 32. Second hub completion member 40 is coupled to second incomplete hub 16 so that a second composite hub 54 is formed on second end 22 of primary body 12. Composite hub 54 is a male hub secured by snapping together internal annular ridge 38 of first engagement 36 with external annular groove 44 of second engagement 42.

Instead of having to stock a PVC backwater valve and an ABS backwater valve, the present invention enables primary body 12 to be kept in stock with a plurality of hub completion members of both PVC and ABS. The type of material that primary body is made from is not critical, as it is the hub completion members that determine compatibility with the material out of which the pipe is made. The same primary body is used regardless of the type of pipe. When PVC pipe is being used, PVC hub completion members will be used. Conversely, when ABS pipe is being used, ABS hub completion members will be used. As new materials come into usage, such as nylon, hub completion members can be used that are compatible with the material out of which the pipe is made. The reduction in inventory can be dramatic when elbows, tees, line clean outs, adapters, in-line backwater valves, traps, couplings for like diameter pipe and couplings for differing diameter pipe all have bodies with incomplete hubs and the hub completion members can be used interchangeably with each of the various types of pipe fittings.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. Pipe fitting with hub, comprising:
a hollow primary body, at least one incomplete hub integrally formed as part of the primary body, the incomplete hub having a first engagement;
at least one hub completion member separate from the primary body, the at least one hub completion member having a second engagement adapted to engage the first engagement, thereby coupling the at least one hub completion member to the incomplete hub to form a composite hub on the primary body.

2. The pipe fitting with hub as defined in claim 1, wherein the primary body and the hub completion member are made from dissimilar materials.

3. The pipe fitting with hub as defined in claim 1, wherein the first engagement is one of an internal thread and an external thread and the second engagement is the other of the internal thread and the external thread.

4. The pipe fitting with hub as defined in claim 1, wherein the first engagement is one of an annular ridge and an annular groove and the second engagement is the other of the annular ridge and the annular groove.

5. Pipe fitting with hub, comprising:
a hollow primary body,
at least one incomplete hub integrally formed as part of the primary body, the incomplete hub having a first engagement in the form of internal engagement threads;
a hub completion member separate from the primary body, the hub completion member having a second engagement in the form of external engagement threads adapted to engage the internal engagement threads, thereby coupling the at hub completion member to the incomplete hub to form a composite hub on the primary body.

6. Pipe fitting with hub, comprising:
a hollow primary body,
at least one incomplete hub integrally formed as part of the primary body, the incomplete hub having a first engagement in the form of an internal annular ridge;
a hub completion member separate from the primary body, the hub completion member having a second engagement in the form of an external annular groove adapted to engage the internal annular ridge, thereby coupling the hub completion member to the incomplete hub to form a composite hub on the primary body.
